(19) United States
(12) Patent Application Publication
(10) Pub. No.: US 2012/0002181 A1
(43) Pub. Date: Jan. 5, 2012

(54) EXPOSURE CONTROL SYSTEM AND EXPOSURE CONTROL METHOD

(76) Inventor: Suigen KYOH, Yokohama-shi (JP)

(21) Appl. No.: 13/172,747

(22) Filed: Jun. 29, 2011

(30) Foreign Application Priority Data
Jun. 29, 2010 (JP) 2010-148123

(51) Int. Cl. G03B 27/52

(52) U.S. Cl. 355/30

(57) ABSTRACT

According to one embodiment, an exposure control system includes an overlap judgment unit that judges whether a position of a foreign matter that adheres to a back surface of a photomask overlaps a position of a chuck that holds the photomask when the photomask is held by the chuck, and an exposure decision unit that decides to hold the photomask by the chuck and perform exposure, when it has been determined that the position of the foreign matter does not overlap the position of the chuck.

### CROSS-REFERENCE TO RELATED APPLICATIONS

This application is based upon and claims the benefit of priority from Japanese Patent Application No. 2010-148123, filed Jun. 29, 2010; the entire contents of which are incorporated herein by reference.

### FIELD

Embodiments described herein relate generally to an exposure control system and an exposure control method.

### BACKGROUND

To cope with miniaturization of a semiconductor device, reflection type exposure using EUV (extreme ultraviolet) light has been suggested.

Since this EUV reflection type exposure is carried out in a vacuum chamber, a photomask is held by an electrostatic chuck. As a material of the electrostatic chuck, ceramic is usually utilized. Therefore, ceramic grains separated from the electrostatic chuck may adhere to a back surface of the photomask in some cases. Further, dust may adhere to the back surface of the photomask when the photomask is carried. As a result of the adhesion of a foreign matter onto the back surface of the photomask, appropriate exposure may not be possibly performed.

### BRIEF DESCRIPTION OF THE DRAWINGS

FIG. 1 is a block diagram showing a configuration of an exposure control system according to a first embodiment;

FIG. 2 is a flowchart showing an operation of an exposure control method according to the first embodiment;

FIG. 3 is a view relating to the first embodiment and showing a relationship between a position of a foreign matter and a position of a chuck pin;

FIG. 4 is a block diagram showing a configuration of an exposure control system according to a second embodiment;

FIG. 5 is a block diagram showing a configuration of an exposure judgment unit according to a second embodiment;

FIG. 6 is a flowchart showing an operation of an exposure control method according to the second embodiment;

FIG. 7 is a block diagram showing a configuration of an exposure control system according to a third embodiment;

FIG. 8 is a view relating to the third embodiment and showing a relationship between a position of a foreign matter and a position of a chuck pin;

FIG. 9 is a flowchart showing an operation of an exposure control method according to the third embodiment;

FIG. 10 is a block diagram showing a configuration of an exposure control system according to a fourth embodiment;

FIG. 11 is a block diagram showing a configuration of an exposure judgment unit according to the fourth embodiment; and

FIG. 12 is a flowchart showing an operation of an exposure control method according to the fourth embodiment.

### DETAILED DESCRIPTION

In general, according to one embodiment, an exposure control system includes an overlap judgment unit that judges whether a position of a foreign matter that adheres to a back surface of a photomask overlaps a position of a chuck that holds the photomask when the photomask is held by the chuck; and an exposure decision unit that decides to hold the photomask by the chuck and perform exposure, when it has been determined that the position of the foreign matter does not overlap the position of the chuck.

Embodiments will now be described hereinafter with reference to the drawings.

### Embodiment 1

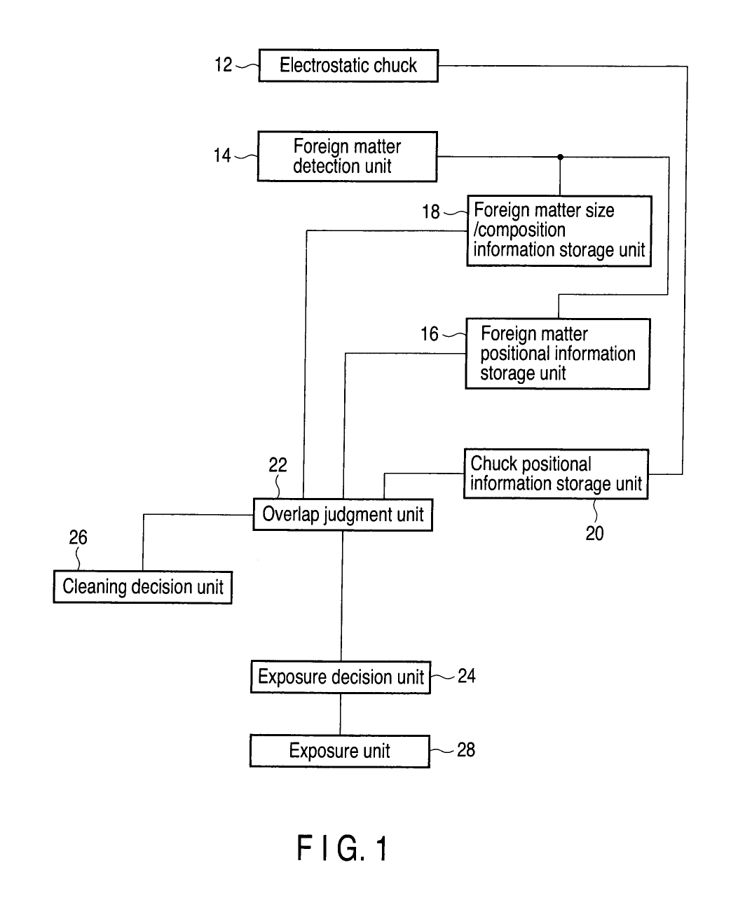

FIG. 1 is a block diagram showing a configuration of an exposure control system according to a first embodiment. This system is a system for EUV reflection type exposure.

This exposure control system has the same basic configuration as that of a regular exposure system (an exposure apparatus), but it also has an intrinsic configuration that is not present in the regular exposure system.

An electrostatic chuck 12 holds a photomask for the EUV reflection type exposure. As a material of a chuck pin of the electrostatic chuck 12, ceramic is used.

A foreign matter detection unit 14 detects a foreign matter that adheres to a back surface of the photomask. The foreign matter detection unit 14 detects various kinds of information concerning foreign matters. Specifically, the foreign matter detection unit 14 detects a position of a foreign matter, a size of a foreign matter, a composition of a foreign matter (a type of a foreign matter), and others.

A foreign matter positional information storage unit 16 stores positional information of the foreign matter detected by the foreign matter detection unit 14. A foreign matter size/composition information storage unit 18 stores size information and composition information of the foreign matter detected by the foreign matter detection unit 14. A chuck positional information storage unit 20 stores positional information of the chuck pin of the electrostatic chuck 12.

An overlap judgment unit 22 judges whether a position of the foreign matter that adheres to the back surface of the photomask overlaps a position of the chuck pin when the photomask is held by the chuck based on the positional information of the foreign matter stored in the foreign matter positional information storage unit 16 and the positional information of the chuck pin stored in the chuck positional information storage unit 20. That is, the overlap judgment unit 22 judges whether the foreign matter that adheres to the back surface of the photomask comes into contact with the chuck pin when the photomask is held by the chuck.

An exposure decision unit 24 decides to hold the photomask by the chuck and perform the exposure. In this embodiment, if the overlap judgment unit 22 has determined that the position of the foreign matter and the position of the chuck do not overlap each other, the exposure decision unit 24 decides to hold the photomask by the chuck and perform the exposure.

A cleaning decision unit 26 decides to clean the photomask in order to remove the foreign matter when it has been determined that the position of the foreign matter overlaps the position of the chuck.

An exposure unit 28 carries out the exposure when the exposure decision unit 24 has decided to perform the exposure. In this exposure unit 28, the reflection type exposure is carried out by using EUV light, and a pattern on the photomask is transferred to a photoresist on a semiconductor substrate (a semiconductor wafer).

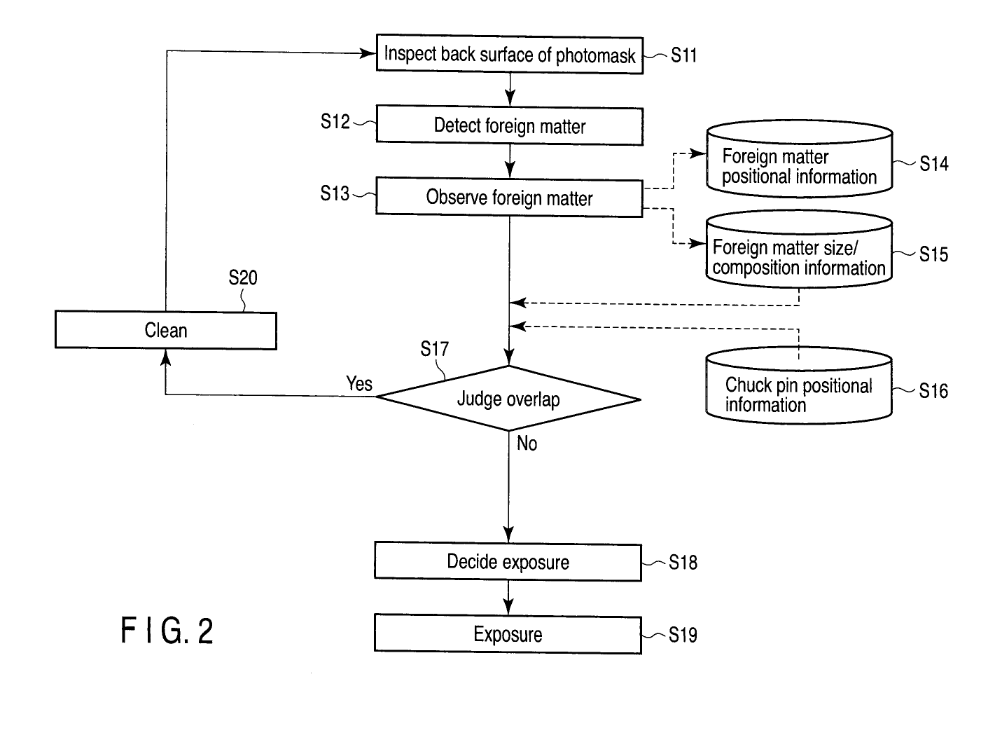

FIG. 2 is a flowchart showing an operation of an exposure control method according to this embodiment.

First, the photomask is carried into the exposure system (the exposure apparatus), and the foreign matter detection unit 14 inspects the back surface of the photomask (S11). When a foreign matter has been detected on the back surface of the photomask (S12), the foreign matter is observed (S13). As a result, positional information of the foreign matter, size information of the foreign matter, and composition information of the foreign matter are acquired. The foreign matter positional information storage unit 16 stores the positional information of the foreign matter (S14), and the foreign matter size/composition information storage unit 18 stores the size information of the foreign matter and the composition information of the foreign matter (S15). The positional information of the chuck pin of the electrostatic chuck 12 is previously acquired and stored in the chuck positional information storage unit 20 (S16).

Subsequently, the overlap judgment unit 22 judges whether the position of the foreign matter that adheres to the back surface of the photomask overlaps the position of the chuck pin when the photomask is held by the chuck based on the positional information of the foreign matter stored in the foreign matter positional information storage unit 16 and the positional information of the chuck pin stored in the chuck positional information storage unit 20 (S17).

When it has been determined that the back surface of the photomask does not have the foreign matter that adheres thereto and that the position of the foreign matter that adheres to the back surface of the photomask does not overlap the position of the chuck pin, the exposure decision unit 24 decides to perform the exposure (S18). In this case, the exposure unit 28 carries out the exposure. That is, the reflection type exposure is carried out by using the EUV light, and a pattern on the photomask is transferred to the photoresist on the semiconductor substrate (the semiconductor wafer) (S19).

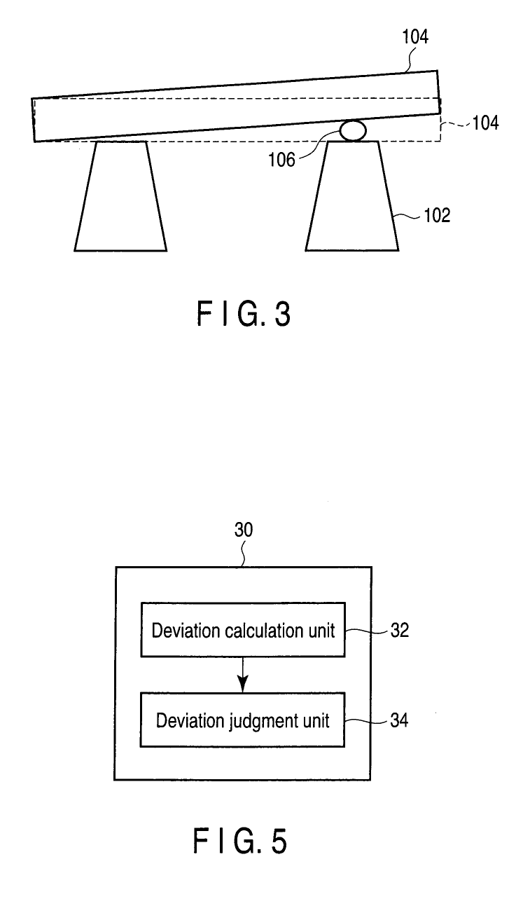

When it has been determined that the position of the foreign matter overlaps the position of the chuck, the cleaning decision unit 26 decides to clean the photomask in order to remove the foreign matter, whereby the back surface of the photomask is cleaned (S20). That is, as shown in FIG. 3, when the position of the foreign matter 106 overlaps the position of the chuck pin 102, the photomask 104 inclines, and hence the appropriate exposure (appropriate pattern transfer) may not be possibly performed. Thus, in this embodiment, the photomask is cleaned to remove the foreign matter.

After performing the cleaning, the photomask is again carried into the exposure system (the exposure apparatus), and the foreign matter detection unit 14 inspects the back surface of the photomask.

As described above, in this embodiment, whether the position of the foreign matter that adheres to the back surface of the photomask overlaps the position of the chuck (the chuck pin) that holds the photomask is judged. Furthermore, when it has been determined that the position of the foreign matter does not overlap the position of the chuck, performing the exposure is decided. In the reflection type photomask, even if the foreign matter adheres to a surface (the back surface) on the reverse side of a pattern formed surface, the exposure is not adversely affected, and hence the appropriate exposure (the appropriate pattern transfer) can be carried out as long as the position of the foreign matter does not overlap the position of the chuck. Therefore, in this embodiment, since cleaning can be performed only when the position of the foreign matter overlaps the position of the chuck, the number of times of cleaning can be reduced, thereby improving a throughput in a manufacturing process of a semiconductor device.

### Embodiment 2

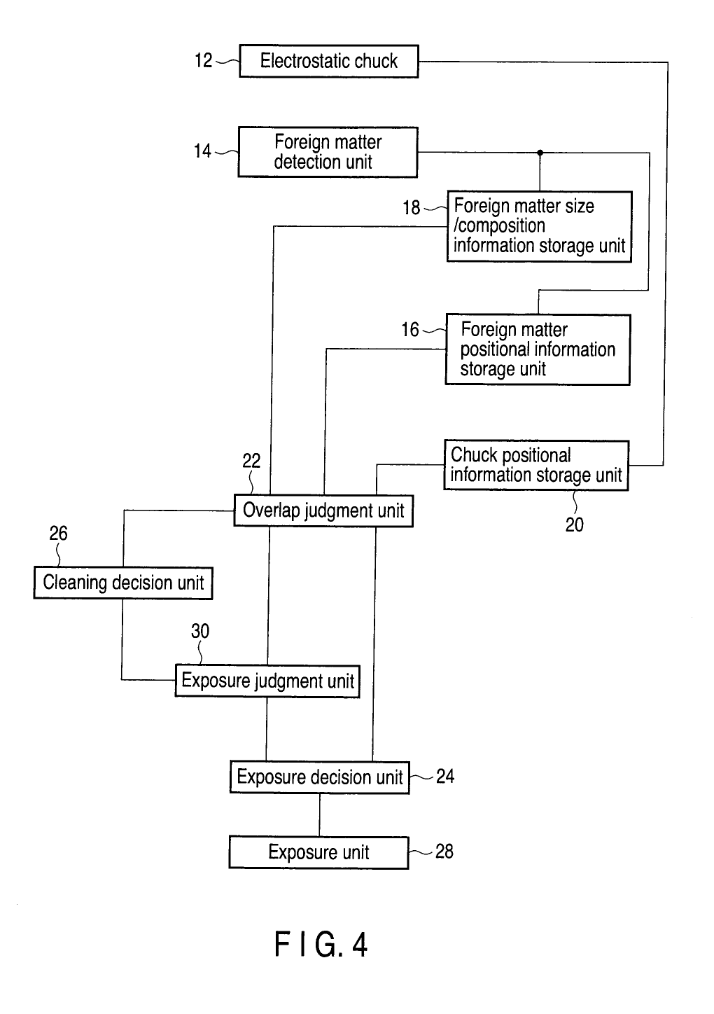

FIG. 4 is a block diagram showing a configuration of a exposure control system according to a second embodiment. It is to be noted that a basic configuration is the same as a configuration of the first embodiment depicted in FIG. 1, thereby omitting a description about the matters explained in the first embodiment.

In this embodiment, an exposure judgment unit 30 is provided in addition to the configuration depicted in FIG. 1. This exposure judgment unit 30 judges whether exposure is possible in a state that a position of a foreign matter overlaps a position of a chuck pin when an overlap judgment unit 22 has determined that the position of the foreign matter overlaps the position of the chuck pin. Moreover, when the exposure judgment unit 30 has determined that the exposure is possible, an exposure decision unit 24 decides to hold a photomask by a chuck and perform the exposure. When the exposure judgment unit 30 has not determined that the exposure is possible, a cleaning decision unit 26 decides to clean the photomask.

FIG. 5 is a block diagram showing a configuration of the exposure judgment unit 30 according to this embodiment. As shown in FIG. 5, the exposure judgment unit 30 includes a deviation calculation unit 32 that calculates a deviation of a surface of the photomask from an ideal plane and a deviation judgment unit 34 that judges whether the calculated deviation meets predetermined conditions.

The deviation calculation unit 32 calculates an inclination of the photomask caused due to a foreign matter based on positional information of the foreign matter stored in a foreign matter positional information storage unit 16 and size/composition information of the foreign matter stored in a foreign matter size/composition information storage unit 18. That is, in case that the foreign matter that adheres to the back surface of the photomask overlaps the chuck pin when the photomask is held by the electrostatic chuck, since the photomask is inclined due to the foreign matter sandwiched between the photomask and the chuck pin, an inclination angle in this situation is calculated. When the photomask is inclined due to the foreign matter and irregularities are produced on the surface (a pattern formed surface) of the photomask, the ideal plane of the photomask surface deviates from the actual photomask surface. As a result, on a surface of a semiconductor substrate (a semiconductor wafer), defocusing occurs or a pattern position is shifted. However, if the deviation calculated by the deviation calculation unit 32 is small and falls within a predetermined acceptable range, desired lithography conditions can be met even though exposure is carried out in a state that the foreign matter adheres (a state that the foreign matter is in contact with the chuck pin). Thus, the deviation judgment unit 34 judges whether the deviation calculated by the deviation calculation unit 32 meets the predetermined conditions (whether the deviation falls within the predetermined acceptable range). If it has been determined that the predetermined conditions are met, the exposure decision unit 24 decides to carry out the exposure in the state that the foreign matter adheres (the state that the foreign matter is in contact with the chuck pin). If it has been determined that the predetermined conditions are not met, since the desired lithography conditions cannot be satisfied, the cleaning decision unit 26 decides to perform cleaning.

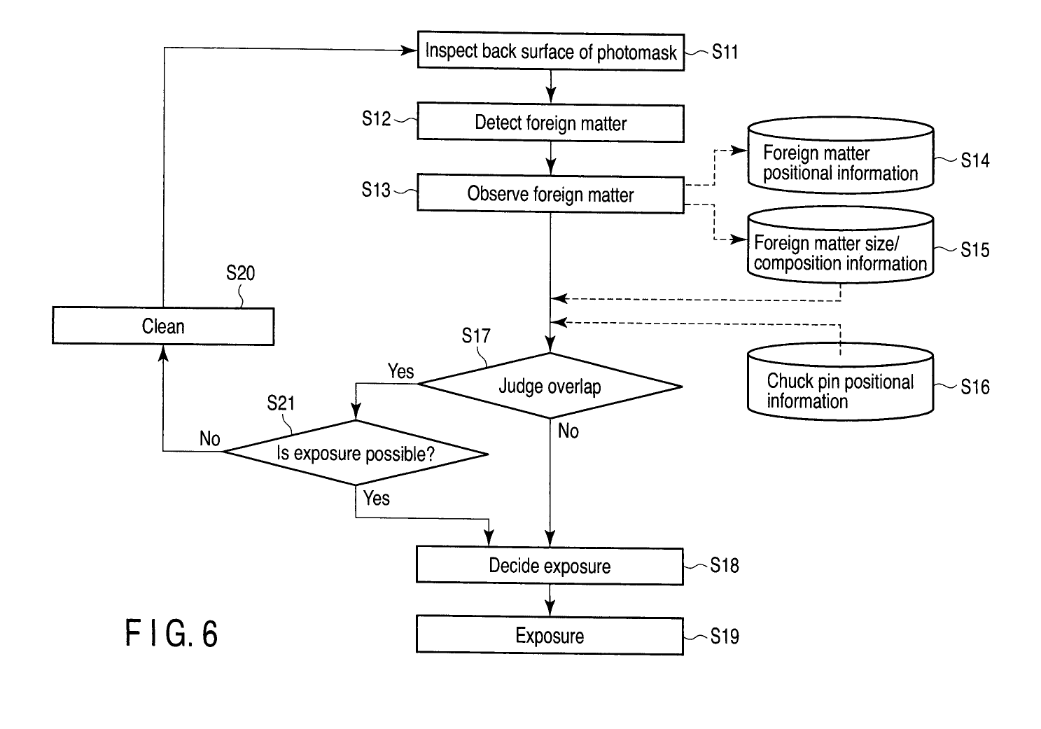

FIG. 6 is a flowchart showing an operation of an exposure control method according to this embodiment. It is to be noted that a basic operation is equal to that in the first embodiment depicted in FIG. 2 and hence a description on the matters explained in the first embodiment will be omitted.

In this embodiment, when the overlap judgment unit 22 has determined that the position of the foreign matter overlaps the position of the chuck pin, the exposure judgment unit 30 determines whether the exposure is possible in the state that the position of the foreign matter overlaps the position of the chuck pin (S21). Specifically, as described above, the deviation of the surface of the photomask from the ideal plane is calculated by the deviation calculation unit 32, and whether the calculated deviation meets the predetermined conditions is judged by the deviation judgment unit 34. Additionally, when it has been determined that the predetermined conditions are met, the exposure decision unit 24 decides to perform the exposure in the state that the foreign matter adheres (S18), thereby carrying out the exposure (S19). When it has been determined that the predetermined conditions are not met, the cleaning decision unit 26 decides to perform cleaning, thereby carrying out the cleaning (S20). It is to be noted that when the overlap judgment unit 22 has determined that the position of the foreign matter does not overlap the position of the chuck pin, the exposure decision unit 24 decides to perform the exposure (S18) and the exposure is carried out (S19) like the first embodiment.

As described above, in this embodiment, like the first embodiment, when it has been determined that the position of the foreign matter does not overlap the position of the chuck, since performing the exposure is decided, the number of times of cleaning can be reduced, whereby a throughput in a manufacturing process of a semiconductor device can be improved. Moreover, in this embodiment, when it has been determined that the exposure is possible in the state that the position of the foreign matter overlaps the position of the chuck even though the position of the foreign matter has been determined to overlap the position of the chuck, carrying out the exposure is decided. Therefore, the number of times of cleaning can be further reduced, and the throughput in the manufacturing process of a semiconductor device can be further improved.

### Embodiment 3

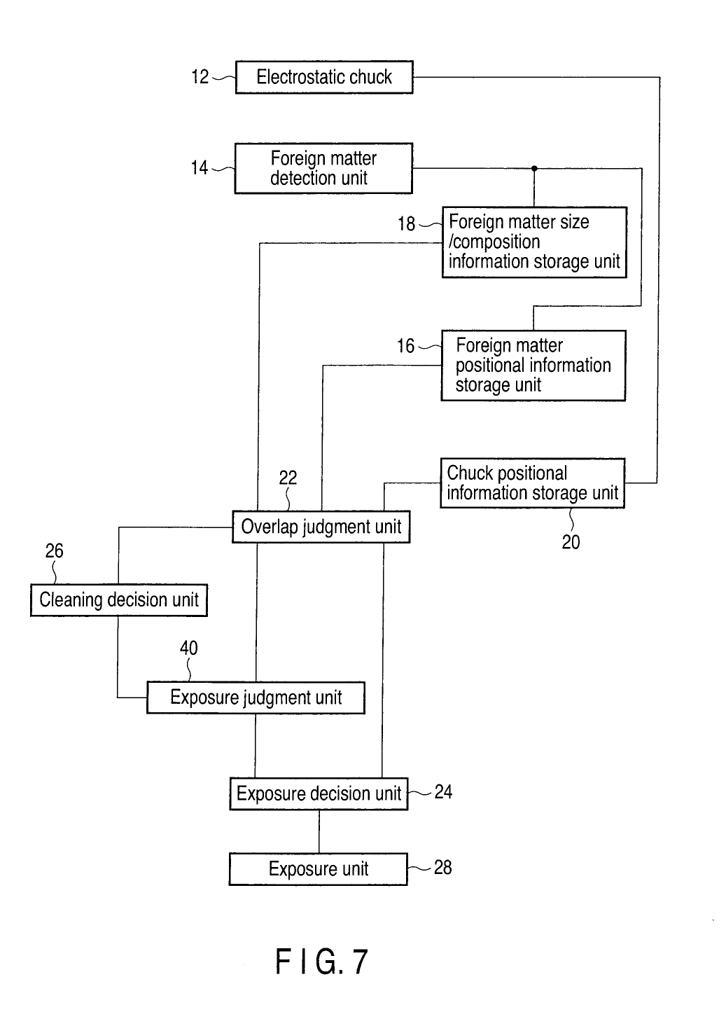

FIG. 7 is a block diagram showing a configuration of an exposure control system according to a third embodiment. It is to be noted that a basic configuration is equal to that of the first embodiment shown in FIG. 1 and hence a description on the matters in the first embodiment will be omitted.

In this embodiment, an exposure judgment unit 40 is provided in addition to the configuration depicted in FIG. 1. This exposure judgment unit 40 judges whether exposure is possible in a state that a position of a foreign matter and a position of a chuck pin are relatively shifted when an overlap judgment unit 22 has determined that the position of the foreign matter overlaps the position of the chuck pin. Further, when the exposure judgment unit 40 has determined that the exposure is possible, an exposure decision unit 24 decides to hold a photomask by a chuck and perform the exposure. When the exposure judgment unit 40 has not determined that the exposure is possible, a cleaning decision unit 26 decides to clean the photomask. A description on the exposure judgment unit 40 according to this embodiment will now be added.

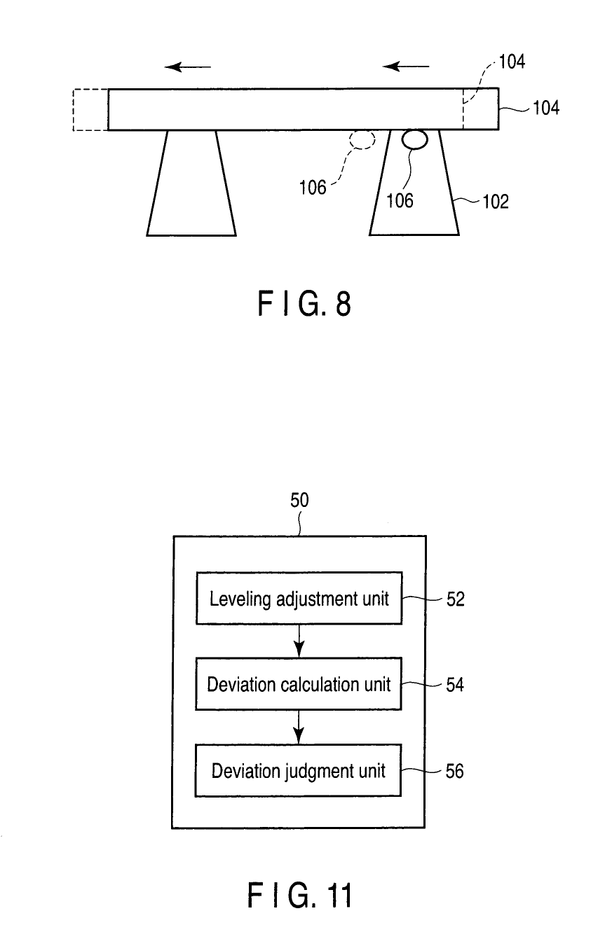

The exposure judgment unit 40 judges whether the exposure is possible by relatively shifting the position of the foreign matter and the position of the chuck based on positional information of the foreign matter stored in a foreign matter positional information storage unit 16 and positional information of the chuck pin stored in a chuck positional information storage unit 20. Specifically, as shown in FIG. 8, the position of the photomask 104 and the position of the chuck pin 102 are relatively shifted so that the position of the foreign matter 106 does not overlap the position of the chuck pin 102. Furthermore, when it has been determined that predetermined lithography conditions are met at the time of performing the exposure in such a state, i.e., when it has been determined that appropriate exposure (appropriate pattern transfer) can be effected, carrying out the exposure is decided.

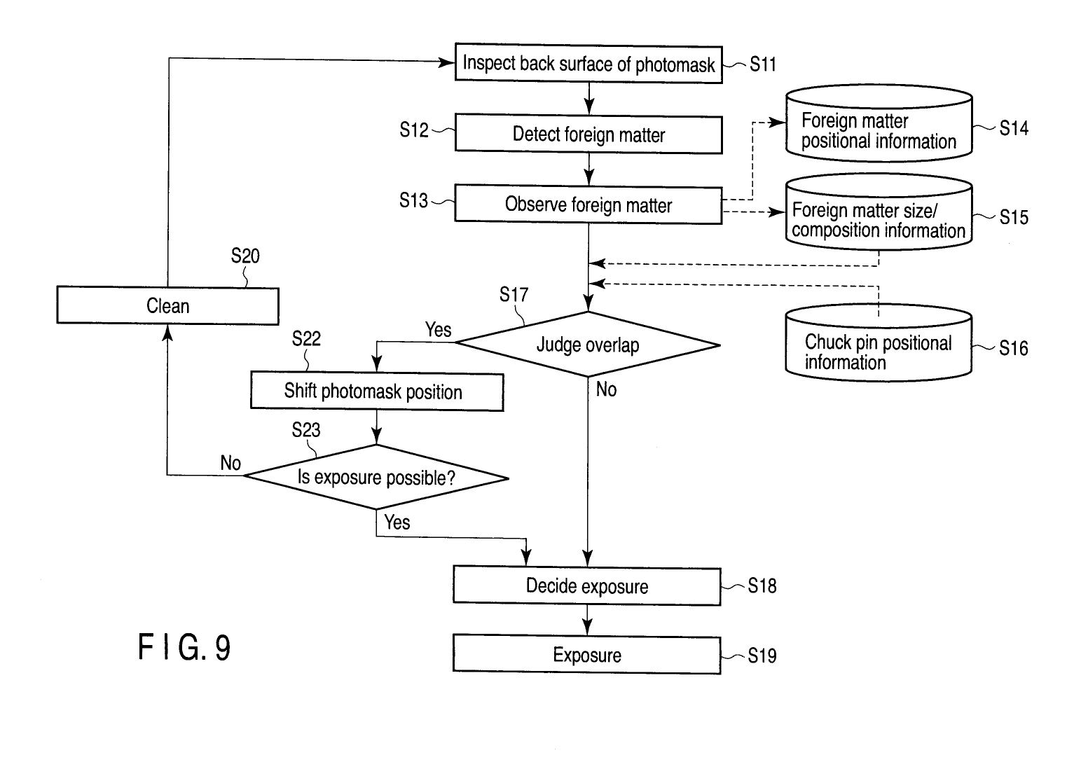

FIG. 9 is a flowchart showing an operation of an exposure control method according to this embodiment. It is to be noted that, since a basic operation is equal to that in the first embodiment shown in FIG. 2 and hence a description on the matters in the first embodiment will be omitted.

In this embodiment, when the overlap judgment unit 22 has determined that the position of the foreign matter overlaps the position of the chuck pin, a position of the photomask is shifted (S22). Specifically, the position of the photomask is shifted in such a manner that the position of the foreign matter does not overlap the position of the chuck pin. Furthermore, the exposure judgment unit 40 judges whether the exposure is possible in a state that the position of the foreign matter and the position of the chuck pin are relatively shifted (S23). When it has been determined that the exposure is possible, the exposure decision unit 24 decides to perform the exposure in the state that the position of the photomask has been shifted (S18), thereby performing the exposure (S19). That is, performing the exposure in the state that the foreign matter has adhered is decided, and the exposure is carried out. At the time of the exposure, a shift amount of the photomask is output, and the exposure is performed in a state that the photomask is shifted by the output shift amount. When it has been determined that the predetermined conditions are not met, the cleaning decision unit 26 decides to effect cleaning, and the cleaning is effected (S20). It is to be noted that, when the overlap judgment unit 22 has determined that the position of the foreign matter does not overlap the position of the chuck pin, the exposure decision unit 24 decides to perform the exposure (S18) and the exposure is carried out (S19) like the first embodiment.

As described above, in this embodiment, like the first embodiment, when it has been determined that the position of the foreign matter does not overlap the position of the chuck, since performing the exposure is decided, the number of times of cleaning can be reduced, thereby improving a throughput in a manufacturing process of a semiconductor device. Further, in this embodiment, when it has been determined that the exposure is possible in the state that the position of the foreign matter and the position of the chuck pin are relatively shifted even though the position of the foreign matter overlaps the position of the chuck, performing the exposure is decided. Therefore, the number of times of cleaning can be further reduced, and the throughput in the manufacturing process of the semiconductor device can be further improved.

Furthermore, although the position of the photomask is shifted in such a manner that the position of the foreign matter does not overlap the position of the chuck pin in the foregoing embodiment, the position of the foreign matter may overlap the position of the chuck pin after the shifting as long as the appropriate exposure (the appropriate pattern transfer) can be performed.

### Embodiment 4

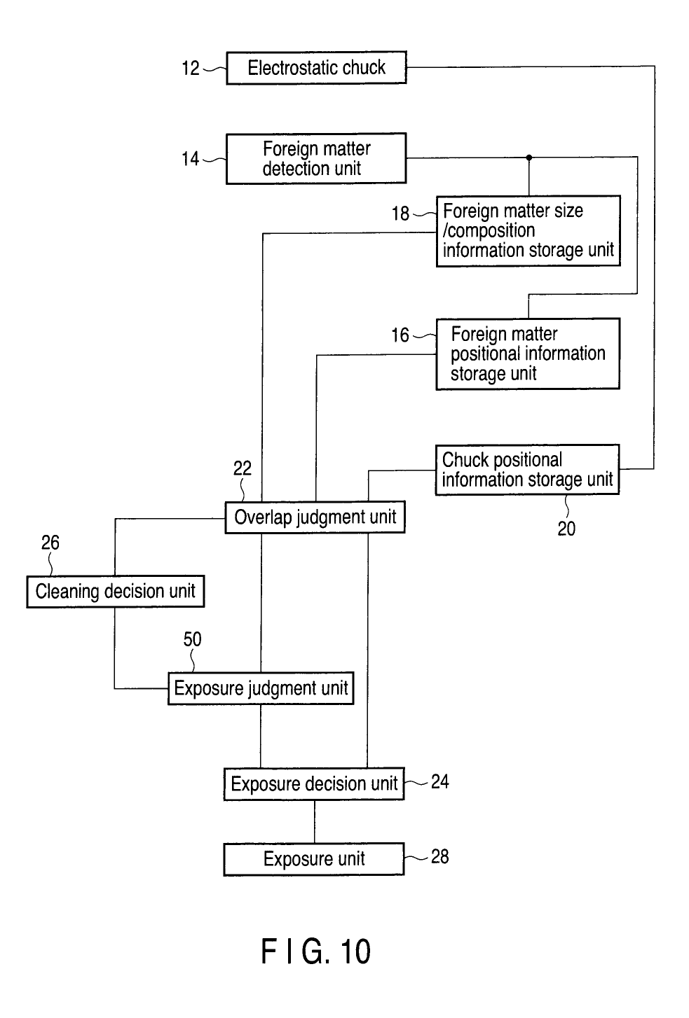

FIG. 10 is a block diagram showing a configuration of an exposure control system according to a fourth embodiment. It is to be noted that a basic configuration is equal to that in the first embodiment depicted in FIG. 1, and hence a description on the matters in the first embodiment will be omitted.

In this embodiment, an exposure judgment unit 50 is provided in addition to the configuration in FIG. 1. This exposure judgment unit 50 judges whether exposure is possible by leveling adjustment of a photomask even in a state that a position of a foreign matter overlaps a position of a chuck pin when an overlap judgment unit 22 has determined that the position of the foreign matter overlaps the position of the chuck pin. Moreover, an exposure decision unit 24 decides to hold the photomask by a chuck and perform the exposure when the exposure judgment unit 50 has determined that the exposure is possible. When the exposure judgment unit 50 has not determined that the exposure is possible, a cleaning decision unit 26 decides to clean the photomask. A description on the exposure judgment unit 50 according to this embodiment will now be added.

FIG. 11 is a block diagram showing a configuration of the exposure judgment unit 50 according to this embodiment. As shown in FIG. 11, the exposure judgment unit 50 includes a leveling adjustment unit 52 that assumes a state that the photomask is inclined to adjust leveling, a deviation calculation unit 54 that calculates a deviation of a surface of the photomask from an ideal plane, and a deviation judgment unit 56 that judges whether the calculated deviation meets predetermined conditions.

The leveling adjustment unit 52 assumes a state that the leveling of the photomask is adjusted when a position of the foreign matter overlaps a position of the chuck pin. The deviation calculation unit 54 calculates a deviation of the surface of the photomask subjected to the leveling adjustment from the ideal plane of the photomask surface (a pattern formed surface) when the photomask is inclined to adjust the leveling in a state that the position of the foreign matter overlaps the position of the chuck pin. The deviation judgment unit 56 judges whether the deviation calculated by the deviation calculation unit 54 meets predetermined conditions (whether the deviation falls within a predetermined acceptable range). When it has been determined that the predetermined conditions are met, the exposure decision unit 24 decides to perform exposure in a state that the leveling adjustment has been carried out and a state that the foreign matter has adhered (a state that the foreign matter is in contact with the chuck pin). In reality, it is preferable to perform the leveling adjustment in such a manner that the deviation becomes minimum. When it has been determined that the predetermined conditions are not met, since desired lithography conditions cannot be satisfied, the cleaning decision unit 26 decides to effect cleaning.

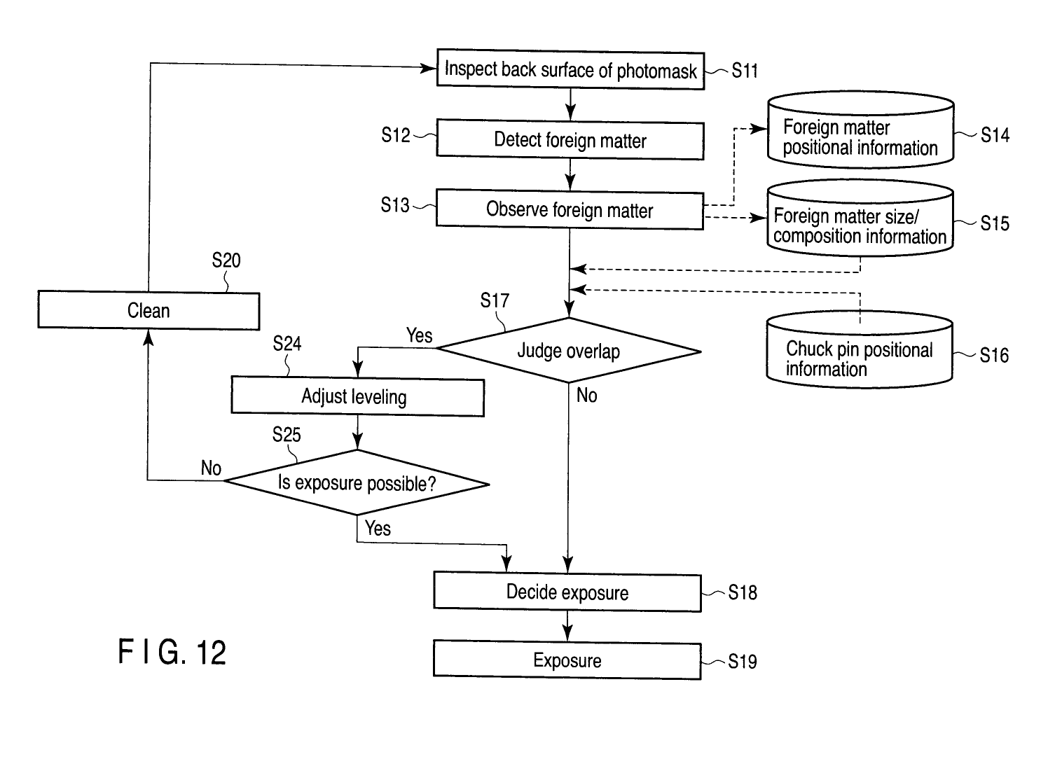

FIG. 12 is a flowchart showing an operation of an exposure control method according to this embodiment. It is to be noted that a basic operation is equal to that in the first embodiment depicted in FIG. 2, and a description on the matters in the first embodiment will be omitted.

In this embodiment, when the overlap judgment unit 22 has determined that the position of the foreign matter overlaps the position of the chuck pin, a state that the photomask is inclined to perform leveling adjustment is assumed (S24). Moreover, whether the exposure is possible in the leveling adjusted state is judged (S25). When it has been determined that the exposure is possible, the exposure decision unit 24 decides to perform the exposure in the state that the photomask has been subjected to the leveling adjustment (S18), thereby performing the exposure (S19). That is, effecting the exposure in the state that the foreign matter has adhered is decided, whereby the exposure is carried out. An inclination angle of the photomask is output at the time of the exposure, and the exposure is carried out in a state that the photomask is inclined at the output inclination angle. When it has been determined that the predetermined conditions are not met, the cleaning decision unit 26 decides to perform the cleaning, thus effecting the cleaning (S20). It is to be noted that, when the overlap judgment unit 22 has determined that the position of the foreign matter does not overlap the position of the chuck pin, the exposure decision unit 24 decides to carry out the exposure (S18) and the exposure is performed (S19) like the first embodiment.

As described above, in this embodiment, like the first embodiment, when it has been determined that the position of the foreign matter does not overlap the position of the chuck, since performing the exposure is decided, the number of times of cleaning can be reduced, and a throughput in a manufacturing process of a semiconductor device can be improved. Additionally, in this embodiment, when it has been determined that the exposure is possible in the state that the photomask has been subjected to the leveling adjustment even though the position of the foreign matter has been determined to overlap the position of the chuck, performing the exposure is decided. Therefore, the number of times of cleaning can be further reduced, and the throughput in the manufacturing process of the semiconductor device can be further improved.

It is to be noted that the description has been given on the assumption that the foreign matter detection unit 14 is included in the exposure control system, i.e., the exposure system (the exposure device) in the first to fourth embodiments, the foreign matter detection unit 14 does not have to be necessarily included in the exposure control system.

As described above, according to the foregoing embodiments, the exposure control system and the exposure control method that can carry out the appropriate exposure can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An exposure control system comprising:
an overlap judgment unit that judges whether a position of a foreign matter that adheres to a back surface of a photomask overlaps a position of a chuck that holds the photomask when the photomask is held by the chuck; and
an exposure decision unit that decides to hold the photomask by the chuck and perform exposure, when it has been determined that the position of the foreign matter does not overlap the position of the chuck.

2. The system according to claim 1, further comprising a cleaning decision unit that decides to clean the photomask, when it has been determined that the position of the foreign matter overlaps the position of the chuck.

3. The system according to claim 1, further comprising an exposure judgment unit that judges whether the exposure is possible in a state that the position of the foreign matter overlaps the position of the chuck, when it has been determined that the position of the foreign matter overlaps the position of the chuck,
wherein the exposure decision unit decides to hold the photomask by the chuck and perform the exposure, when the exposure judgment unit has determined that the exposure is possible.

4. The system according to claim 3,
wherein the exposure judgment unit comprises:
a deviation calculation unit that calculates a deviation of a surface of the photomask from an ideal plane; and
a deviation judgment unit that judges whether the calculated deviation meets predetermined conditions.

5. The system according to claim 4,
wherein the deviation calculation unit calculates a deviation of the surface of the photomask from the ideal plane when the photomask is inclined.

6. The system according to claim 1, further comprising an exposure judgment unit that judges whether the exposure is possible in a state that the position of the foreign matter and the position of the chuck are relatively shifted, when it has been determined that the position of the foreign matter overlaps the position of the chuck,
wherein the exposure decision unit decides to hold the photomask by the chuck and perform the exposure, when the exposure judgment unit has determined that the exposure is possible.

7. The system according to claim 1, further comprising a foreign matter position detection unit that detects the position of the foreign matter that adheres to the back surface of the photomask.

8. The system according to claim 1,
wherein the photomask is a reflection type photomask.

9. The system according to claim 1,
wherein the chuck is an electrostatic chuck.

10. An exposure control method comprising:
judging whether a position of a foreign matter that adheres to a back surface of a photomask overlaps a position of a chuck that holds the photomask when the photomask is held by the chuck; and
deciding to hold the photomask by the chuck and perform exposure, when it has been determined that the position of the foreign matter does not overlap the position of the chuck.

11. The method according to claim 10, further comprising deciding to clean the photomask, when it has been determined that the position of the foreign matter overlaps the position of the chuck.

12. The method according to claim 10, further comprising judging whether the exposure is possible in a state that the position of the foreign matter overlaps the position of the chuck, when it has been determined that the position of the foreign matter overlaps the position of the chuck,
wherein holding the photomask by the chuck and performing the exposure are decided, when it has been determined that the exposure is possible.

13. The method according to claim 12,
wherein judging whether the exposure is possible comprises:
calculating a deviation of a surface of the photomask from an ideal plane; and
judging whether the calculated deviation meets predetermined conditions.

14. The method according to claim 13,
wherein calculating the deviation comprises calculating a deviation of the surface of the photomask from the ideal plane when the photomask is inclined.

15. The method according to claim 10, further comprising judging whether the exposure is possible in a state that the position of the foreign matter and the position of the chuck are relatively shifted, when it has been determined that the position of the foreign matter overlaps the position of the chuck,
wherein holding the photomask by the chuck and performing the exposure are decided, when it has been determined that the exposure is possible.

16. The method according to claim 10, further comprising detecting the position of the foreign matter that adheres to the back surface of the photomask.

17. The method according to claim 10,
wherein the photomask is a reflection type photomask.

18. The method according to claim 10,
wherein the chuck is an electrostatic chuck.
